(19) United States
(12) Patent Application Publication
(10) Pub. No.: US 2014/0132899 A1
(43) Pub. Date: May 15, 2014

(54) PHOTOSENSITIVE MONOMER, LIQUID CRYSTAL COMPOSITION AND LIQUID CRYSTAL PANEL THEREOF

(71) Applicant: Chung-Ching Hsieh, Guangdong (CN)

(72) Inventor: Chung-Ching Hsieh, Guangdong (CN)

(73) Assignee: SHENZHEN CHINA STAR OPTOELECTRONICS TECHNOLOGY CO., LTD., Guangdon (CN)

(21) Appl. No.: 13/701,807

(22) PCT Filed: Nov. 19, 2012
(86) PCT No.: PCT/CN12/84826

§ 371 Date: Dec. 3, 2012

(30) Foreign Application Priority Data
Nov. 15, 2012 (CN) 201210460363.4

(51) Int. Cl. G02F 1/1337; C09K 19/56

(52) U.S. Cl. CPC G02F 1/133711; C09K 19/56
USPC 349/106; 349/123; 560/86; 560/194; 252/299.01

(57) ABSTRACT

The present invention provides a photosensitive monomer, a liquid crystal composition containing the photosensitive monomer and a vertical alignment liquid crystal panel. The range of absorption wavelength of the photosensitive monomer of the present invention overlaps with the range of an ultraviolet lamp by increasing the length of a hard core. Thus, comparing with the conventional reactive monomer (RM), the photosensitive monomer of the present invention has a faster curing speed to solve the image sticking issue due to a high monomer residue.

### FIELD OF THE INVENTION

The present invention relates to a photosensitive monomer, a liquid crystal composition added with a photosensitive monomer having trifluoromethyl and a vertical alignment-liquid crystal panel.

### BACKGROUND OF THE INVENTION

Liquid crystal display (LCD) is a flat panel display device using the characteristics of the liquid crystal materials to display images which has many advantages, such as lightweight, low driving voltage and low power consumption, and has becoming the mainstream products in the whole consumer market.

Liquid crystal panel is the most important component of the LCD. Liquid crystal panel will produce ionization due to the degradation of the materials in the panel after long-term use, thus affecting the display quality of the liquid crystal panel, and the most common issue is surface type image sticking. This influence residual issue is related to excessive level of reactive monomers left in liquid crystal composition of the liquid crystal panel.

Furthermore, referring now to FIG. 1, a schematic view of the alignment process of a traditional liquid crystal panel is shown in FIG. 1. The fast response liquid crystal compositions 30′ contain one or more type of liquid crystal molecules 31′ and reactive monomers (RM) 32′. The liquid crystal compositions 30′ are diffused on the surface of the alignment film 20′ of the substrate 10′ by one-drop filling technology (ODF), and the alignment process is completed after several processes including applying voltage, first UV exposure, and second UV exposure processes, etc. The FIG. 1 reveals that after completing the alignment process, quite a few of RM are still remained in the liquid crystal composition, and thus cause the liquid crystal panel to suffer image sticking (IS) issue. Researches show that the residue of RM is related to the curing ability of the RM.

As a result, it is necessary to provide a new monomer to solve the problems existing in the conventional technologies.

### SUMMARY OF THE INVENTION

The first object of the present invention is to provide a photosensitive monomer having a faster curing speed to solve the image sticking issue due to a high RM residue.

To achieve the above object, the present invention provides a photosensitive monomer included in liquid crystal compositions, which comprises a hard core and polymerizable groups, the polymerizable groups are acrylate groups or methacrylate groups, and the absorption wavelength of the hard core in UV absorption spectrum is in a range from 300 nm to 450 nm.

In one embodiment of the present invention, the photosensitive monomer is represented by the following formula (I):

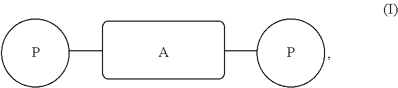

wherein group A is the hard core having at least one benzene ring; and group P is the polymerizable groups.

In one embodiment of the present invention, the photosensitive monomer is represented by the following formula (II):

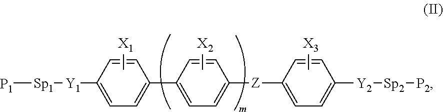

wherein

m is greater than or equal to 0;

group Z is selected from oxygen atom, sulfur atom, carbonyl(—C═O—), caroboxyl(—COO—, —COO—), methoxy(—OCH₂—), methylthio(—CH₂S—, —SCH₂—), thio(—H₂S—, —SH₂—)₉ ethenylcarbonyl(—CH═CH—COO—), carbonylethenyl(—OOC—CH═CH—), difluoromethoxy(—CF₂O—, —OCF₂—), difluoro methylthio(—CF₂S—, —SCF₂—), ethyl(—C₂H₄—), difluoroethane(—CF₂CH₂—, —CH₂CF₂—), tetrafluoroethane(—CF₂CF₂—), vinylene(—CH═CH—), difluoroethenylene(—CF═CF—), ethynyl(—C≡C—) or single bond;

group X₁, X₂ and X₃ are independently selected from hydrogen atom or fluorine atom;

group Y₁ and Y₂ are independently selected from oxygen atom, sulfur atom, methoxy(—OCH₂—), carbonyl(—C═O—), caroboxyl(—COO—, —OCO—), carbamoyl(—CO—N⁰R—, —N⁰R—CO—), methylthio(—SCH₂—, —CH₂S—), ethenylcarbonyl(—CH═CH—COO—), carbonylethenyl(—OOC—CH═CH—) or single bond;

group Sp₁ and Sp₂ are independently a spacer group independently selected from C₁-C₈ alkyl group or single bond; and

group P₁ and P₂ are represented by the following formula (III):

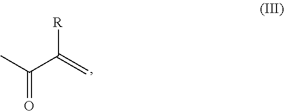

wherein group R is selected from —H or —CH₃.

Preferably,

Group Z is selected from

In a preferred embodiment of the present invention, the photosensitive monomer is represented by the following formula (i), (ii) or (iii):

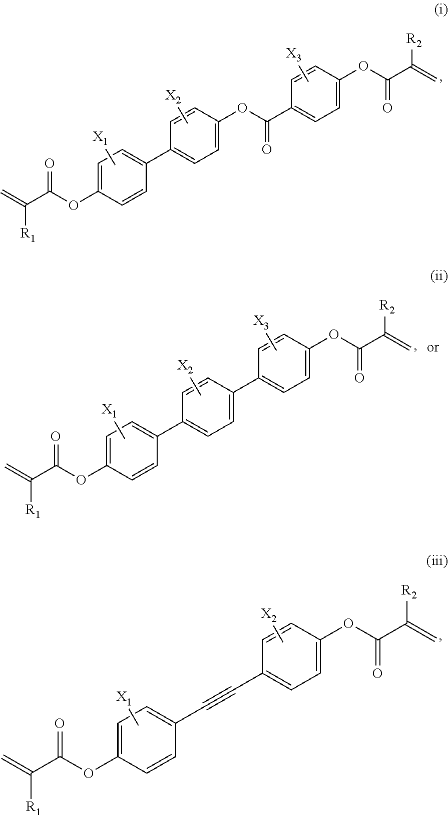

wherein

group R₁, R₂ are independently selected from —H or —CH₃;

group X₁, X₂ and X₃ are independently selected from —H or —F.

The present invention is also to provide a liquid crystal composition for manufacturing a liquid crystal panel, which comprises: at least one type of the photosensitive monomer mentioned above, at least one type of liquid crystal molecule and at least one type of diluents.

In one embodiment of the present invention, the liquid crystal molecule is a vertical alignment liquid crystal molecule (VA-LC) and the diluent is a liquid crystal compound having one or more alkenyl groups.

In one embodiment of the present invention, the liquid crystal composition is a liquid crystal composition of one-drop filling technology.

In a preferred embodiment of the present invention, the weight percentage of each component of the liquid crystal composition is:

| | |
|---|---|
| photosensitive monomer | 0.01% to 0.5%; |
| diluents | 1% to 60%; and |
| liquid crystal molecule | 40% to 99%. |

The present invention is also to provide a liquid crystal panel comprising a first substrate and a second substrate which are equipped with an alignment film, respectively, wherein a liquid crystal composition is dispersed and distributed on surfaces of the alignment films of the first substrate and the second substrate, and the liquid crystal composition contains at least one type of liquid crystal molecule, at least one type of diluents and at least one type of the photosensitive monomer mentioned above.

In one embodiment of the present invention, the liquid crystal molecule is a vertical alignment liquid crystal molecule and the diluent is a liquid crystal compound having one or more alkenyl groups.

In a preferred embodiment of the present invention, the diluent is represented by the following formula (IV) or (V):

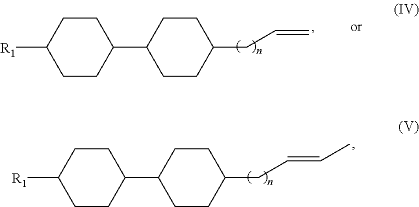

wherein R₁ is a C₁-C₁₀ alkyl group, and n is 1-10.

In one embodiment of the present invention, the alignment film is a vertical alignment type alignment film.

In one embodiment of the present invention, the first substrate is a color filter substrate and the second substrate is a thin film transistor array substrate.

In one embodiment of the present invention, the liquid crystal composition is a liquid crystal composition of one-drop filling technology.

In a preferred embodiment of the present invention, a liquid crystal panel comprising a first substrate and a second substrate which are equipped with an alignment film, respectively, is provided, a liquid crystal composition is dispersed and distributed on surfaces of the alignment films of the first substrate and the second substrate, and the liquid crystal composition contains at least one type of liquid crystal molecule, at least one type of diluents and at least one type of the photosensitive monomer mentioned above; wherein

the liquid crystal molecule is a conventional vertical alignment liquid crystal molecule;

the polymerizable groups of the photosensitive monomer are acrylate groups, the photosensitive monomer contains a hard core and polymerizable groups, the polymerizable groups are acrylate groups or methacrylate groups and the absorption wavelength of the hard core in UV absorption spectrum is in a range from 300 nm to 450 nm, which is represented by the formula (II);

the diluent is a liquid crystal compound containing one or more alkenyl groups and is represented by the following formula (IV) or (V):

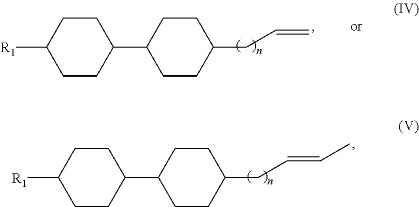

wherein R₁ is a C₁-C₁₀ alkyl group, and n is 1-10; and

the alignment film is a vertical alignment type alignment film.

It should be noted that the liquid crystal molecule in the present invention is a vertical alignment liquid crystal molecule that is already known in the art; and the alignment film is a vertical alignment type alignment film that is already known in the art. The C₁-C₈ alkyl group or C₁-C₁₀ alkyl group means a straight-chain or a branched alkyl group which comprises 1 to 8 or 1 to 10 carbon atoms.

The positive effect of the present invention is that: the photosensitive monomer the present invention provides is a reactive monomer (RM), of which the range of absorption wavelength and the range of an ultraviolet lamp have more overlapping parts. Thus, comparing with the conventional RM, the photosensitive monomer the present invention provides has a faster curing speed to solve the image sticking issue due to a high monomer residue.

### BRIEF DESCRIPTION OF THE DRAWINGS

FIG. 1 is a schematic view of an alignment process of a traditional liquid crystal panel which is made of fast response liquid crystal compositions;

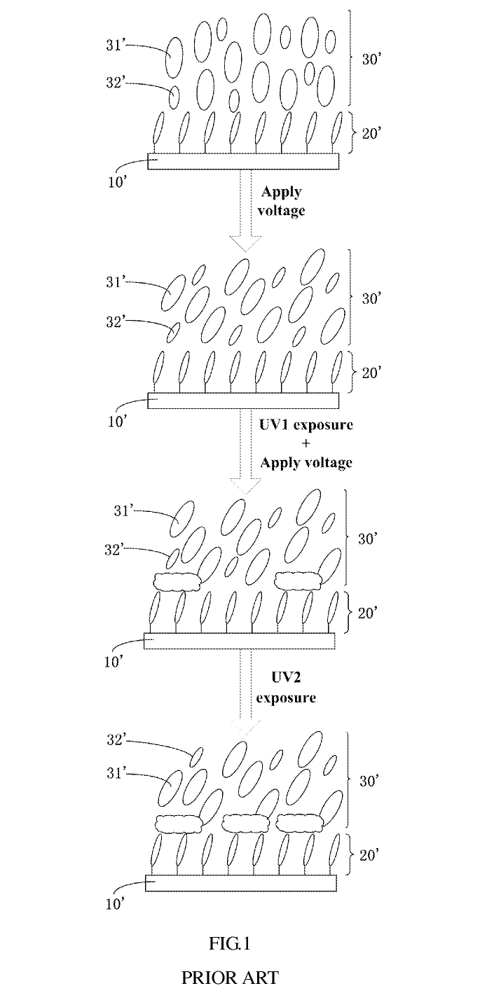

FIG. 2 illustrates a liquid crystal panel having a liquid crystal composition of the present invention; and

FIG. 3 is a schematic view of an alignment process of the liquid crystal panel which is made of the liquid crystal composition of the present invention;

wherein
10′—substrate of liquid crystal panel;
20′—alignment film;
30′—fast response liquid crystal compositions in the conventional technologies;
31′—liquid crystal molecule in the conventional technologies;
32′—reactive monomer (RM) in the conventional technologies;
10—first substrate of liquid crystal panel in one embodiment of the present invention;
11—second substrate of liquid crystal panel in one embodiment of the present invention;
20—first alignment film of liquid crystal panel in one embodiment of the present invention;
21—second alignment film of liquid crystal panel in one embodiment of the present invention;
30—liquid crystal composition of liquid crystal panel in one embodiment of the present invention;
31—liquid crystal molecules of liquid crystal composition of the present invention;
32—diluent of liquid crystal composition of the present invention; and
33—polymerizable monomer of liquid crystal composition of the present invention.

### DESCRIPTION OF THE INVENTION

Embodiments, for purposes of explanation, are set forth in order to provide a thorough understanding of the present invention and not to limit the technical solution of the present invention.

### Example 1

A photosensitive monomer contained in a liquid crystal composition is provided in this embodiment, of which the absorption wavelength in UV absorption spectrum is in a range from 300 nm to 450 nm photosensitive monomer, and the photosensitive monomer is represented by the following formula (I):

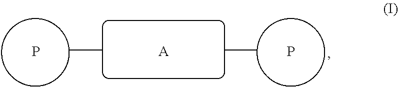

wherein group A is a hard core having at least one benzene ring; and group P is the polymerizable groups selecting from acrylate groups.

According to a preferred embodiment of the present invention, a liquid crystal composition is provided for manufacturing a liquid crystal panel, which comprises at least one type of photosensitive monomer represented by formula (I), at least one type of liquid crystal molecule and at least one type of diluent.

The liquid crystal molecule is a vertical alignment liquid crystal molecule (VA-LC) and the diluent is a liquid crystal compound containing one or more alkenyl groups.

The liquid crystal composition is a liquid crystal composition of one-drop filling technology.

### Example 2

A photosensitive monomer contained in a liquid crystal composition is provided in this embodiment and is represented by the following formula (I):

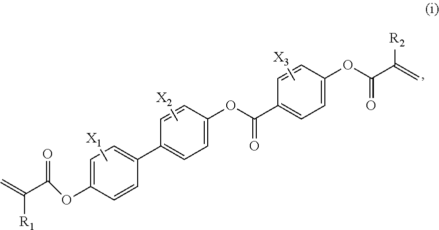

wherein group R₁, R₂ are independently selected from —H or —CH₃ and group X₁, X₂ and X₃ are independently selected from —H or —F.

Furthermore, the scheme of the photosensitive monomer of this embodiment is as follows when the group R₁, R₂, X₁, X₂ and X₃ are —H, respectively.

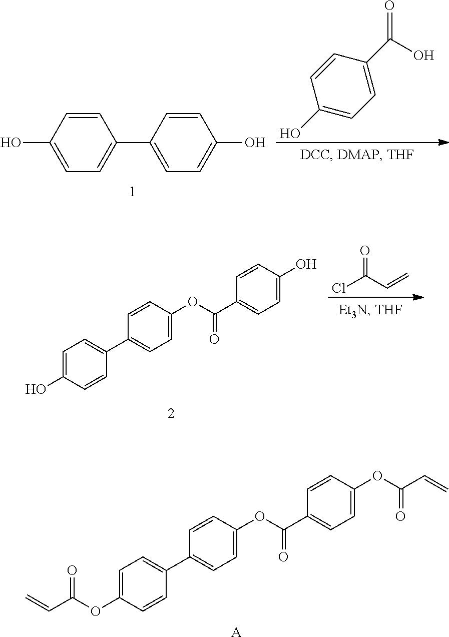

The preparation method thereof is described, as follows:

4 mmol of 4,4′-Dihydroxybiphenyl (compound (1)), 1 mmol of 4-hydroxybenzoic acid, 0.1 mmol of 4-dimethylamiopryidine (DMAP) and 50 milliliter of dehydrated tetrahydrofuran (THF) are loaded into a 250 mL two-neck bottle which is then deaerated and nitrogenated with a vacuum deaerating and dehydrating device for three times, and nitrogen is connected to the drip tube to keep the reaction system anaerobic and anhydrous. Then, under freezing condition, 1.1 mmol of dicyclohexylcarbodiimide (DDC) are loaded into the reaction system which reacts until the next day at the room temperature. The reaction system is suction filtrated with THF, and the filtrate is collected, decompressed and evaporated, extracted with ethyl acrylate (EA) and water, dehydrated with MgSO₄, suction filtrated and evaporated and vacuumed to obtain a yellow solid. Lastly, the yellow solid is purified with ethyl acrylate/Hexane (EA/Hexane= 2/8) through silica gel column chromatography to gain a yellowish solid (2). Certainly, the compound (2) may be recrystallized with tetrahydrofuran/methanol.

4.14 mmol of compound (2) are loaded into a 250 ml two-neck bottle which is then deaerated and nitrogenated with a vacuum deaerating and dehydrating device for three times, and nitrogen is connected to the drip tube to keep the reaction system anaerobic and anhydrous. At the room temperature, 8.28 mmol of triethylamine (Et₃N) and 50 milliliter of dehydrated THF are added and stirred until dissolved. Then, under freezing condition, 9.11 mmol of methacryloyl chloride are loaded into the reaction system which reacts until the next day at the room temperature. The reaction system is suction filtrated with THF, the filtrate is collected, decompressed and evaporated, extracted with EA and water, and the organic layer is dehydrated with MgSO₄, suction filtrated and evaporated and vacuumed to obtain a yellow solid. Lastly, the yellow solid is purified with ethyl acrylate/Hexane (EA/Hexane=⅙) through silica gel column chromatography to gain a yellowish solid, that is, the target product A. Certainly, the target product A may be recrystallized with tetrahydrofuran/methanol (THF/methanol).

### Example 3

A photosensitive monomer contained in a liquid crystal composition is provided in this embodiment and is represented by the following formula (II):

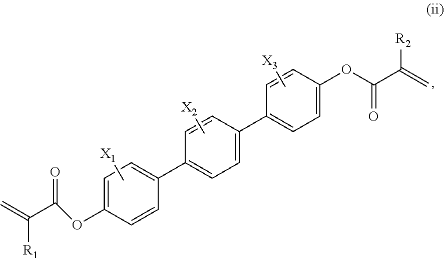

wherein group R₁, R₂ are independently selected from —H or —CH₃ and group X₁, X₂ and X₃ are independently selected from —H or —F.

Furthermore, the scheme of the photosensitive monomer of this embodiment is as follows when the group R₁, R₂, X₁, X₂ and X₃ are —H, respectively.

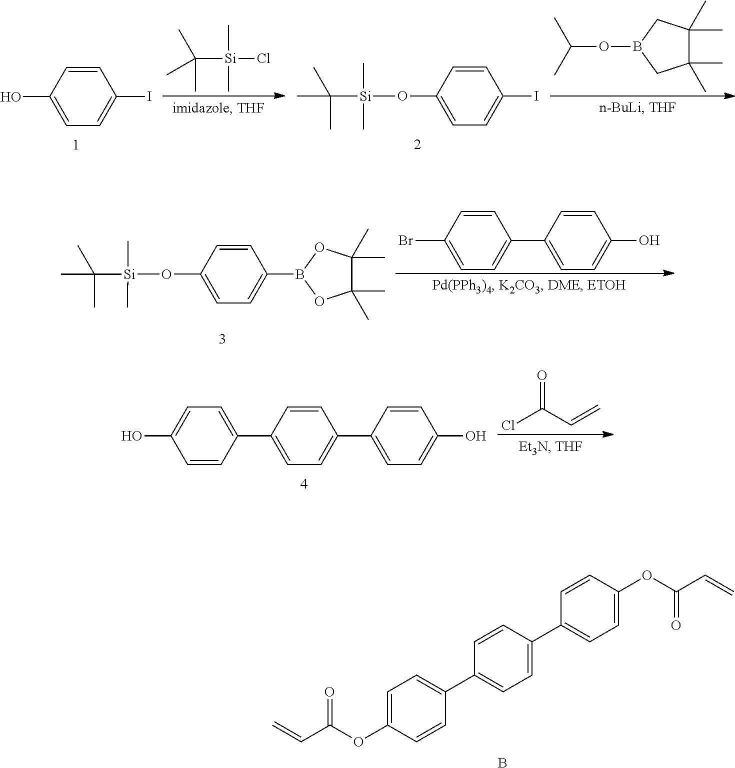

The preparation method thereof is described, as follows:

0.045 mol of iodophenol (compound (1)), 0.064 mol of tert-Butyldimethylsilyl chloride and 0.204 mol of imidiazole are loaded into a 250 mL two-neck bottle, 60 mL of dehydrated THF are loaded into the reaction system which is then stirred for 6 hours. After the reaction system is suction filtrated, most of solvent is removed by using a rotary evaporator. The reaction system is extracted with EA and saturated saline solution, and the filtrate is collected, dehydrated with anhydrous magnesium sulfate, decompressed and evaporated to obtain a light orange liquid. After column chromatography separation, purifying with hexane regarded as an eluent to obtain an orange liquid, which is compound (2). The yield rate is 87%.

10 grams of the compound (2) having been vacuumed and dried are loaded into a 250 mL two-neck bottle which is heated and dried in vacuum, dehydrated THF is sucked and infused into the reactive bottle by a syringe followed by stirring for 5 minutes at −78° C. 44.87 mmol of n-butyllithium are slowly dropped into the reactive bottle and stirred for 2 hours at −78° C., meanwhile the clear solution will turn into a white cloudy solution. Then, 59.83 mmol of 2-isopropoxy-4,4,5,5-tetramethyl-1,3,2-dioxaborolane are slowly dropped into the reactive bottle at −78° C. and reacts overnight while gradually returns to the room temperature. After the reaction is completed, the white solid is suction filtrated, the filtrate is decompressed and evaporated followed by being extracted with EA and water, and an organic layer is collected, dehydrated with anhydrous magnesium sulfate and evaporated to obtain a yellowish liquid. The yellowish liquid is purified with ethyl acrylate/Hexane (EA/Hexane= 1/10) through silica gel column chromatography to gain a yellowish solid, that is, the compound (3). The yield rate is 77% and the melting point of the compound (3) ranges between 45° C. to 46° C.

5 grams of the compound (3) (15 mmol), 14 mmol of 4′-boromo-(1,1′-biphenyl)-4-o and 112 mmol of K₂CO₃ are loaded into a 50 mL two-neck bottle, 0.7 mmol of tetrakis(triphenylphosphine)palladium (Pd(PPh₃)₄) are loaded into the reactive bottle which is then wrapped with an aluminum foil. A mixed solvent of 1,2-dimethoxyethane and ethanol (the volume ratio of the 1,2-dimethoxyethane to ethanol is 3:1) which has been dried in vacuum is loaded into the reactive bottle, and the reaction system reflows and heated at 90° C. for one day. After the reaction is completed, the reaction system is extracted with EA and saturated NH₄Cl and an organic layer is collected, dehydrated with anhydrous magnesium sulfate, evaporated, and lastly purified with EA/Hexane=⅙ through silica gel column chromatography to gain a white solid, that is, the compound (4). The yield rate is 65%.

4.14 mmol of the compound (4) are loaded into a 250 mL two-neck bottle which is then deaerated and nitrogenated with a vacuum deaerating and dehydrating device for three times, and nitrogen is connected to the drip tube to keep the reaction system anaerobic and anhydrous. 8.28 mmol of Et₃N and 50 mL dehydrated THF are added at the room temperature and stirred until dissolved. Under freezing condition, 9.11 mmol of mathacryloyl chloride are loaded into the reaction system which reacts until the next day at the room temperature. The reaction system is suction filtrated with THF, and the filtrate is collected, decompressed and evaporated, extracted with EA and water, dehydrated with MgSO₄, suction filtrated and evaporated and vacuumed to obtain a yellow solid. Lastly, the yellow solid is purified with EA/Hexane=⅙ through silica gel column chromatography to gain a yellowish solid, that is, the target product B. Certainly, the target product B may be recrystallized with tetrahydrofuran methanol (THF/methanol).

### Example 4

A photosensitive monomer contained in a liquid crystal composition is provided in this embodiment and is represented by the following formula (iii):

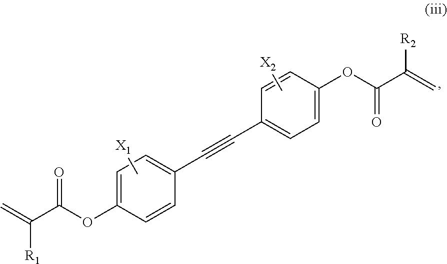

wherein group R₁, R₂ are independently selected from —H or —CH₃ and group X₁, X₂ are independently selected from —H or —F.

Furthermore, the scheme of the photosensitive monomer of this embodiment is as follows when the group R₁, R₂, X₁ and X₂ are —H, respectively.

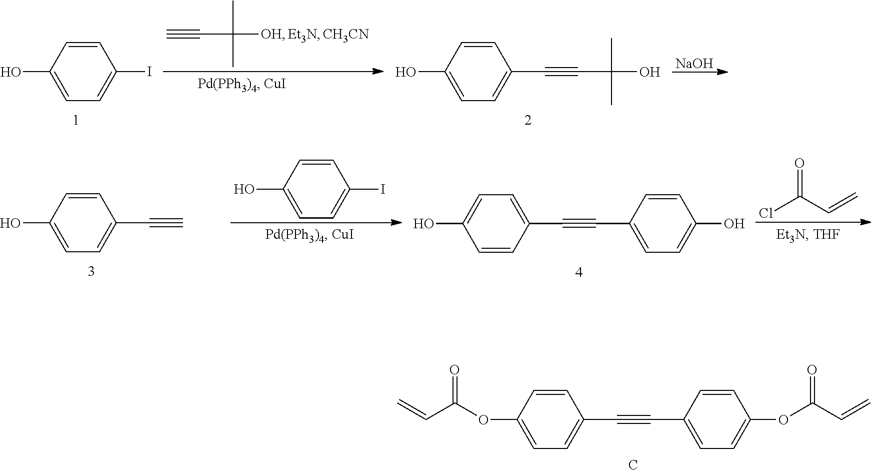

The preparation method thereof is described, as follows:

Compound (1) is dissolved in a mixed solution of CH₃CN [symbol] Et₃N [symbol] Pd(PPh₃)₄ and copper iodide (CuI) under nitrogen environment and heated to 70° C. 2-methyl-3-butyn-2-ol is continually added to the mixed solution drop by drop for 1 hour, and the mixed solution is stirred for 2 hours at the room temperature, 1 hour at 50° C., 30 minutes at 60° C. and 2 hours at 80° C. The mixed solution is hydrated and cooled to the room temperature, and a concentrated hydrochloric acid is added. After being extracted with EA twice, the extracts mixed in an organic layer are washed with water solution and saturated saline solution sequentially and dehydrated with anhydrous MgSO₄. After the solvent is evaporated under low pressure, column chromatography (silica gel, methylbenzene) is performed on the residuals to obtain compound (2).

Sodium hydroxide is added into the compound (2) followed by being stirred for 1 hour at 120° C., and acetone generated is removed by a pressure evaporator. Then, compound (3) is obtained after being purified by column chromatography (silica gel, methylbenzene).

Iodophenol is dissolved in a mixed solution of dimethyl formamide (DMF), Et₃N, Pd(PPh₃)₄ and CuI under nitrogen environment and heated to 55° C. Compound (3) is continually added to the mixed solution drop by drop for 20 minutes, and then stirred for 3 hours. The mixed solution is hydrated and cooled to the room temperature, and concentrated hydrochloric acid is added. After being extracted with EA twice, the extracts mixed in an organic layer are washed with water solution and saturated saline solution sequentially and dehydrated with anhydrous MgSO₄. After the solvent is evaporated under low pressure, column chromatography (silica gel, methylbenzene) is performed on the residuals to obtain compound (4).

4.14 mmol of the compound (4) are loaded into a 250 mL two-neck bottle which is then deaerated and nitrogenated with a vacuum deaerating and dehydrating device for three times, and nitrogen is connected to the drip tube to keep the reaction system anaerobic and anhydrous. 8.28 mmol of Et₃N and 50 mL dehydrated THF are added at the room temperature and stirred until dissolved. Under freezing condition, 9.11 mmol of mathacryloyl chloride are loaded into the reaction system which reacts until the next day at the room temperature. The reaction system is suction filtrated with THF, and the filtrate is collected, decompressed and evaporated, extracted with EA and water, dehydrated with MgSO₄, suction filtrated and evaporated and vacuumed to obtain a yellow solid. Lastly, the yellow solid is purified with EA/Hexane=⅙ through silica gel column chromatography to gain a yellowish solid, that is, the target product C. Certainly, the target product B may be recrystallized with tetrahydrofuran/methanol (THF/methanol).

### Example 5

A liquid crystal panel having at least one type of the photosensitive monomer mentioned above is provided in this embodiment.

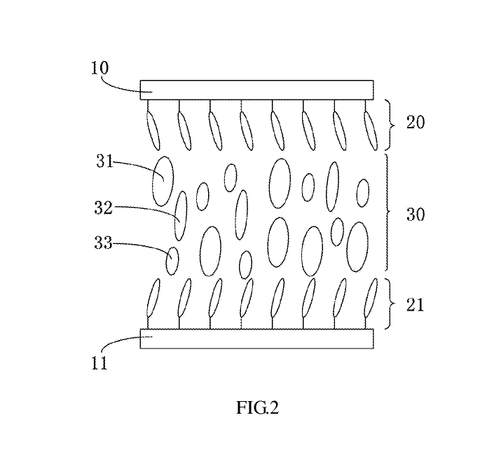

Referring now to FIG. 2, a liquid crystal panel of this embodiment is illustrated. The liquid crystal panel comprises: a first substrate 10 equipped with a first alignment film 20, a second substrate 11 equipped with a second alignment film 21, and a liquid crystal composition 30 filled between the first substrate 10 and the second substrate 11. The liquid crystal composition 30 is distributed on the surface of the first alignment film 20 and the second alignment film 21.

The first substrate 10 is a color filter substrate and the second substrate 11 is a thin film transistor array substrate.

Both of the first alignment film 20 and the second alignment film 21 are vertical alignment type alignment films.

The liquid crystal composition 30 is a liquid crystal composition of one-drop filling technology, which contains at least one type of liquid crystal molecule 31, at least one type of diluent 32 and at least one type of photosensitive monomer 33 mentioned above; wherein the liquid crystal molecule 31 is a conventional vertical alignment liquid crystal molecule.

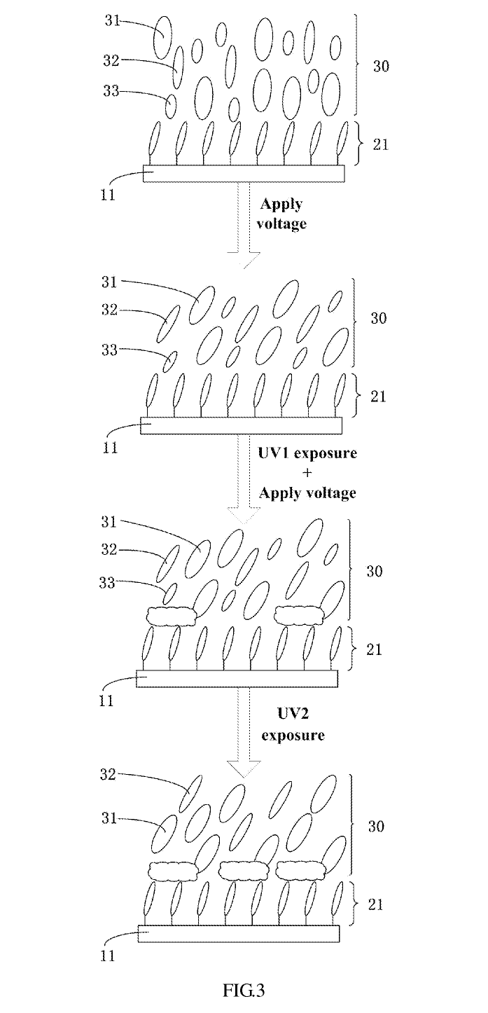

Referring now to FIG. 3, a schematic view of the alignment process of the liquid crystal panel which is made of the liquid crystal composition of the present invention is illustrated. The liquid crystal composition 30 is dispersed and distributed on the surface of the first alignment film 20 of the first substrate 10 and/or the surface of the second alignment film 21 of the second substrate 11 with the one-drop filling technology, and the alignment process is completed after several processes including applying voltage, first UV exposure, and second UV exposure process, etc. It can be seen from FIG. 3 that the photosensitive monomer 33 in the liquid crystal composition 30 reacts completely and there is no residue remained in the liquid crystal composition 30 which improve the image sticking issue of the liquid crystal panel.

The range of absorption wavelength of the photosensitive monomer of the present invention overlaps with the range of an ultraviolet lamp by increasing the length of a hard core. Thus, comparing with the conventional RM, the photosensitive monomer of the present invention has a faster curing speed to solve the image sticking issue due to a high monomer residue.

The present invention has been described with relative embodiments which are examples of the present invention only. It should be noted that the embodiments disclosed are not the limit of the scope of the present invention. Conversely, modifications to the scope and the spirit of the claims, as well as the equal of the claims, are within the scope of the present invention.

1. A photosensitive monomer included in a liquid crystal composition, wherein the photosensitive monomer comprises a hard core and polymerizable groups, the polymerizable groups are acrylate groups or methacrylate groups, and the absorption wavelength of the hard core in UV absorption spectrum is in a range from 300 nm to 450 nm.

2. The photosensitive monomer according to claim 1, wherein the photosensitive monomer is represented by the following formula (I): 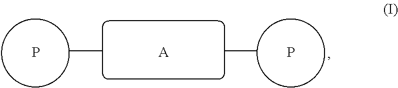
wherein
group A is the hard core having at least one benzene ring; and
group P is the polymerizable groups.

3. The photosensitive monomer according to claim 1, wherein the photosensitive monomer is represented by the following formula (II): 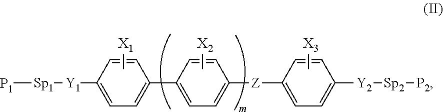
wherein
m is greater than or equal to 0;
group Z is selected from oxygen atom, sulfur atom, carbonyl, caroboxyl, methoxy, methylthio, thio, ethenylcarbonyl, carbonylethenyl, difluoromethoxy, difluoro methylthio, ethyl, difluoroethane, tetrafluoroethane, vinylene, difluoroethenylene, ethynyl or single bond;
group X₁, X₂ and X₃ are independently selected from hydrogen atom or fluorine atom;
group Y₁ and Y₂ are independently selected from oxygen atom, sulfur atom, methoxy, carbonyl, caroboxyl, carbamoyl, methylthio, ethenylcarbonyl, carbonylethenyl or single bond;
group Sp₁ and Sp₂ are independently a spacer group independently selected from C₁-C₈ alkyl group or single bond; and
group P₁ and P₂ are represented by the following formula (III): 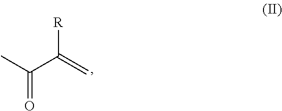
wherein group R is selected from —H or —CH₃.

4. A liquid crystal composition for manufacturing a liquid crystal panel, wherein the liquid crystal composition comprises:
at least one type of the photosensitive monomer according to claim 1;
at least one type of liquid crystal molecule; and
at least one type of diluents.

5. The liquid crystal composition according to claim 4, wherein the liquid crystal molecule is a vertical alignment liquid crystal molecule and the diluent is a liquid crystal compound having one or more alkenyl group.

6. The liquid crystal composition according to claim 5, wherein the liquid crystal composition is a liquid crystal composition of one-drop filling technology.

7. A liquid crystal panel, comprising a first substrate and a second substrate which are equipped with an alignment film, respectively, wherein a liquid crystal composition is dispersed and distributed on surfaces of the alignment films of the first substrate and the second substrate, and the liquid crystal composition contains at least one type of liquid crystal molecule, at least one type of diluents and at least one type of the photosensitive monomer according to claim 1.

8. The liquid crystal panel according to claim 7, wherein the liquid crystal molecule is a vertical alignment liquid crystal molecule and the diluent is a liquid crystal compound having one or more alkenyl groups.

9. The liquid crystal panel according to claim 7, wherein the alignment film is a vertical alignment type alignment film.

10. The liquid crystal panel according to claim 7, wherein the first substrate is a color filter substrate, and the second substrate is a thin film transistor array substrate.
